(19) United States
(12) Patent Application Publication
(10) Pub. No.: US 2019/0363396 A1
(43) Pub. Date: Nov. 28, 2019

(54) LITHIUM SECONDARY BATTERY

(71) Applicant: NEC CORPORATION, Tokyo (JP)

(72) Inventor: Takuya HASEGAWA, Tokyo (JP)

(73) Assignee: NEC CORPORATION, Tokyo (JP)

(21) Appl. No.: 16/332,839

(22) PCT Filed: Aug. 4, 2017
(86) PCT No.: PCT/JP2017/028408

§ 371 Date: Mar. 13, 2019

(30) Foreign Application Priority Data
Sep. 14, 2016 (JP) 2016-179359

(51) Int. Cl. H01M 10/0525; H01M 4/505; H01M 4/38; H01M 4/48; H01M 10/0569; H01M 10/0568

(52) U.S. Cl. CPC H01M 10/0525; H01M 4/505; H01M 4/386; H01M 4/483; H01M 2220/20; H01M 10/0568; H01M 2300/004; H01M 2300/0034; H01M 10/0569

(57) ABSTRACT

A lithium secondary battery having a positive electrode comprises a solid solution of Li₂MnO₃ and LiMO₂; a negative electrode comprises at least one negative electrode active material selected from the group consisting of metal silicon, alloys comprising silicon and silicon oxides represented by a composition formula SiOₓ where 0<x≤2, and a polyacrylic acid; and an electrolyte solution comprises an electrolyte solvent comprising a cyclic carbonate, a fluorine-containing phosphate ester and a fluorine-containing ether, and a supporting salt comprising Li, wherein an amount of the cyclic carbonate is 10 volume % or more and less than 40 volume %, an amount of the fluorine-containing phosphate ester is 20 volume % or more and 50 volume % or less, and an amount of the fluorine-containing ether is 25 volume % or more and 70 volume % or less with respect to a total amount of the cyclic carbonate, the fluorine-containing phosphate ester and the fluorine-containing ether.

### TECHNICAL FIELD

The present invention relates to a battery, a method for manufacturing the same and a vehicle equipped with the battery.

### BACKGROUND ART

Lithium secondary batteries are used for various purposes and are required to have higher energy density. Patent document 1 discloses a solid solution of Li₂MnO₃ and LiMO₂ (M is a metal element) as a positive electrode active material that operates at high voltage. In addition, silicon materials are known as negative electrode active materials having high capacity. For this reason, it is expected that a battery having high energy density can be obtained by combining the solid solution positive electrode active material and the silicon material.

### CITATION LIST

Patent Document
Patent Document 1: WO2014/027572

### SUMMARY OF INVENTION

### Technical Problem

However, a battery using the above mentioned solid solution positive electrode active material has high voltage and thus has problems such as gas generation from an electrolyte solution and low cycle retention rate after repetition of charge and discharge cycles. In particular, when the silicon material is used as a negative electrode active material, the above problems are not improved even with an electrolyte solution having high voltage resistance. In view of the above mentioned problems, the purpose of the present invention is to provide a lithium secondary battery which solves the low cycle retention rate.

### Solution to Problem

The lithium secondary battery of the present invention is characterized in that a positive electrode comprises a positive electrode active material represented by the following formula (1) or (2); a negative electrode comprises at least one negative electrode active material selected from the group consisting of silicon metal, alloys comprising silicon and silicon oxides represented by a composition formula SiOₓ where 0<x≤2, and polyaclylic acid; and an electrolyte solution comprises an electrolyte solvent comprising a cyclic carbonate, a fluorine-containing phosphate ester and a fluorine-containing ether and a supporting salt comprising Li, wherein an amount of the cyclic carbonate is 10 volume % or more and less than 40 volume %, an amount of the fluorine-containing phosphate ester is 20 volume % or more and 50 volume % or less, and an amount of the fluorine-containing ether is 25 volume % or more and 70 volume % or less with respect to a total amount of the cyclic carbonate, the fluorine-containing phosphate ester and the fluorine-containing ether.

xLi₂MnO₃—(1—x)LiMO₂ (1)

wherein x is in a range of 0.1<x<0.8, and M is at least one element selected from the group consisting of Mn, Fe, Co, Ni, Ti, Al and Mg.

Li(LiₓM_{1-x-y}Mn_{y})O₂ (2)

wherein x and y are in ranges of 0.1≤x≤0.3 and 0.33≤y≤0.8, and M is at least one element selected from the group consisting of Fe, Co, Ni, Ti, Al and Mg.

### Advantageous Effect of Invention

According to the present invention, a lithium secondary battery improved in cycle characteristics can be provided.

### BRIEF DESCRIPTION OF DRAWING

FIG. 1 is an exploded perspective view showing a basic structure of a film package battery.

FIG. 2 is a cross-sectional view schematically showing a cross section of the battery of FIG. 1.

FIG. 3 is a three phase diagram showing a mix ratio range in gray color in which a specific amount of LiPF₆ cannot be mixed uniformly with an electrolyte solvent consisting of a cyclic carbonate, a fluorine-containing phosphate ester and a fluorine-containing ether.

### DESCRIPTION OF EMBODIMENTS

Each constituent of the lithium secondary battery of the present invention will be described below.

### <Positive Electrode>

The positive electrode comprises a current collector and a positive electrode mixture layer which is provided on the current collector and comprises a positive electrode active material, a binder and optionally a conductive assisting agent.

In the present invention, the positive electrode comprises the solid solution positive electrode active material of Li₂MnO₃ and LiMO₂, wherein M is at least one element selected from the group consisting of Mn, Fe, Co, Ni, Ti, Al and Mg (hereinafter, this is also referred to as Mn213 positive electrode active material). The Mn213 positive electrode active materials are represented by the following formula (1).

xLi₂MnO₃—(1—x)LiMO₂ (1)

wherein x is in a range of 0.1<x<0.8, and M is at least one element selected from the group consisting of Mn, Fe, Co, Ni, Ti, Al and Mg.

The Mn213 positive electrode active materials may be also represented by the following formula (2). The Mn213 positive electrode active materials represented by formula (1) and formula (2) include overlapping composition range. The Mn213 positive electrode used herein may be represented by either formula (1) or formula (2).

Li(LiₓM_{1-x-y}Mn_{y})O₂ (2)

wherein x and y are in ranges of 0.1≤x≤0.3 and 0.33≤y≤0.8, and M is at least one element selected from the group consisting of Fe, Co, Ni, Ti, Al and Mg.

Other positive electrode active materials may be additionally used, but the amount of the Mn213 positive electrode active material is preferably 30 weight % or more, more preferably 80 weight % or more, and may be 100 weight % of the total amount of the positive electrode active material. Other positive electrode active materials are not particularly limited and may be appropriately determined by those skilled in the art. The positive electrode active materials are materials capable of absorbing and desorbing lithium. Herein, the positive electrode active materials do not include materials not absorbing and desorbing lithium, such as binders.

Examples of the positive electrode binder include polyvinylidene fluoride, vinylidene fluoride-hexafluoropropylene copolymer, vinylidene fluoride-tetrafluoroethylene copolymer, polytetrafluoroethylene, polypropylene, polyethylene, polyimide, polyamideimide and the like. In addition to the above, styrene butadiene rubber (SBR) and the like may be exemplified. When an aqueous binder such as an SBR emulsion is used, a thickener such as carboxymethyl cellulose (CMC) can also be used. The above mentioned positive electrode binders may be mixed and used. The amount of the positive electrode binder is preferably 2 to 10 parts by weight based on 100 parts by weight of the negative electrode active material, from the viewpoint of the sufficient binding strength and the high energy density being in a trade-off relation with each other.

For a coating layer containing the positive electrode active material, a conductive assisting agent may be added for the purpose of lowering the impedance. Examples of the conductive assisting agent include, flake-like, soot, and fibrous carbon fine particles and the like, for example, graphite, carbon black, acetylene black, vapor grown carbon fibers and the like.

As the positive electrode current collector, from the viewpoint of electrochemical stability, aluminum, nickel, copper, silver, and alloys thereof are preferred. As the shape thereof, foil, flat plate, mesh and the like are exemplified. In particular, a current collector using aluminum, aluminum alloy or iron-nickel-chromium-molybdenum based stainless steel is preferable.

The positive electrode according to the present embodiment can be produced by preparing a slurry comprising the positive electrode active material, the binder and a solvent and applying this on the positive electrode current collector to form the positive electrode mixture layer.

### <Negative Electrode>

The negative electrode comprises a current collector and a negative electrode mixture layer which is provided on the current collector and comprises a negative electrode active material, a binder and optionally conductive assisting agent.

As the negative electrode active material, a material comprising silicon as a constituent element (hereinafter, also referred to as a silicon material) is used. Examples of the silicon material include metal silicon, alloys comprising silicon, silicon oxides denoted by composition formula SiOₓ (0<x≤2) and the like. Other metals used in the alloys comprising silicon are preferably selected from the group consisting of Li, Al, Ti, Pb, Sn, In, Bi, Ag, Ba, Ca, Hg, Pd, Pt, Te, Zn and La. The amount of the silicon material is not particularly limited. The amount of the silicon material is preferably 5 weight % or more and more preferably 70 weight % or more, and may be 100 weight % of the total amount of the negative electrode active material. The negative electrode active materials are materials capable of absorbing and desorbing lithium. Herein, the negative electrode active materials do not include materials not absorbing and desorbing lithium, such as binders.

The silicon material may be used in combination with other negative electrode active materials. In particular, it is preferred to use the silicon material together with carbon. The carbon alleviates the effect of expansion and contraction of the silicon material, and thereby cycle characteristics of the battery can be improved. The silicon material and the carbon may be mixed and used, and also the silicon material particles whose surfaces are coated with the carbon may be used. Examples of the carbon include graphite, amorphous carbon, graphene, diamond-like carbon, carbon nanotube, and composites thereof. Here, highly crystalline graphite is highly electroconductive, and has excellent adhesion to a negative electrode current collector composed of a metal such as copper as well as voltage flatness. On the other hand, low-crystallinity amorphous carbon shows relatively small volume expansion, is thus highly effective in lessening the volume expansion of the entire negative electrode, and is unlikely to undergo degradation resulting from non-uniformity such as grain boundaries and defects.

Negative electrode active materials other than the carbon, which can be used in combination with the silicon material, also include metals and metal oxides other than silicon. Examples of the metal include Li, Al, Ti, Pb, Sn, In, Bi, Ag, Ba, Ca, Hg, Pd, Pt, Te, Zn, La, and alloys of two or more of these. Also, these metals or alloys may contain one or more non-metal elements. Examples of the metal oxide include aluminum oxide, tin oxide, indium oxide, zinc oxide, lithium oxide, and composites of these. Also, for example, 0.1 to 5 weight % of one or two or more elements selected from nitrogen, boron, and sulfur can be added to the metal oxide. In this way, the electroconductivity of the metal oxide can be enhanced.

In the present invention, polyacrylic acid is used as a binder in the negative electrode. Cycle characteristics of the battery can be improved using the polyacrylic acid as a binder.

The polyacrylic acid comprises an (meth)acrylic acid monomer unit denoted by the following formula (3). Herein, the term, “(meth)acrylic acid” means acrylic acid and methacrylic acid.

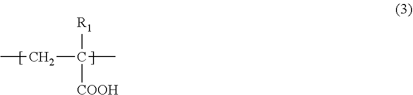

wherein R₁ represents a hydrogen atom or methyl group.

The carboxylic acid in the monomer unit represented by formula (3) may be a carboxylic acid salt, such as a carboxylic acid metal salt. The metal is preferably a monovalent metal. Examples of the monovalent metal include alkali metals (for example, Na, Li, K, Rb, Cs, Fr and the like) and precious metals (for example, Ag, Au, Cu and the like). When the polyacrylic acid contains the carboxylic acid salt in at least part of the monomer units, the adhesiveness to the constituent materials of the electrode mixture layer may be further improved in some cases.

The polyacrylic acid may comprise other monomer units. When the polycarylic acid further comprises monomer units other than (meth)acrylic acid monomer units, the peel strength between the electrode mixture layer and the current collector may be improved in some cases. Examples of other monomer units include monomer units derived from monomers such as acids having ethylenically unsaturated group, for example, monocarboxylic acid compounds such as crotonic acid and pentenoic acid, dicarboxylic acid compounds such as itaconic acid and maleic acid, sulfonic acid compounds such as vinylsulfonic acid, and phosphonic acid compounds such as vinylphosphonic acid; aromatic olefins having acidic group such as styrene sulfonic acid and styrene carboxylic acid; (meth)acrylic acid alkyl esters; acrylonitrile; aliphatic olefins such as ethylene, propylene, and butadiene; aromatic olefins such as styrene; and the like. In addition, other monomer units may be monomer units constituting a known polymer that is used in a binder of a secondary battery. If present, acids may be replaced with their salts in these monomer units.

In addition, in the polyacrylic acid according to present embodiment, at least one hydrogen atom of a main chain and a side chain may be substituted by halogen (fluorine, chlorine, boron, iodine, etc.) or the like.

In the case where the polyacrylic acid according to present embodiment is a copolymer containing two or more types of monomer units, the copolymer may be a random copolymer, an alternating copolymer, a block copolymer, a graft copolymer or a combination thereof.

The lower limit of the amount of the polyacrylic acid used in the negative electrode is preferably 1 part by weight or more and more preferably 2 parts by weight or more, and the upper limit is preferably 20 parts by weight or less and more preferably 10 weight parts by weight or less, based on 100 parts by weight of the negative electrode active material. Other binders may be used in combination with the polyacrylic acid. Examples of other binders include the same binders as those above exemplified as the positive electrode binders.

To the negative electrode, a conductive assisting agent may be added for the purpose of lowering the impedance. Examples of the conductive assisting agent include, flake-like, and fibrous carbon fine particles and the like, for example, graphite, carbon black, acetylene black, ketchen black, vapor grown carbon fibers and the like.

As the negative electrode current collector, from the viewpoint of electrochemical stability, copper, stainless steel, nickel, cobalt, titanium, gadolinium, and alloys thereof may be used, and stainless steel is particularly preferred. As the stainless steel, martensitic type, ferrite type and ferritic-austenitic two phase type may be used. For example, JIS400 series such as SUS402J having a chromium content of 13% may be used as the martensitic type, JIS 400 series such as SUS430 having a chromium content of 17% may be used as the ferrite type, JIS300 series such as SUS329J4L having a chromium content of 25%, a nickel content of 6% and a molybdenum content of 3% may be used as the ferritic-austenitic two phase type, and composite alloys thereof may be used. As the shape thereof, foil, flat plate, mesh and the like are exemplified.

The negative electrode according to the present embodiment can be produced by preparing a slurry comprising the negative electrode active material, the binder and a solvent and applying this on the negative electrode current collector to form the negative electrode mixture layer.

### <Electrolyte Solution>

The electrolyte solution comprises an electrolyte solvent comprising a cyclic carbonate, a fluorine-containing phosphate ester and a fluorine-containing ether. In addition, the electrolyte solution comprises a supporting salt comprising Li.

The cyclic carbonate is not particularly limited, but there can be used a compound having a ring in which two oxygen atoms of carbonate group (—O—C(═O)—O—) and a hydrocarbon group, such as alkylene group or alkenylene group are bonded. The number of carbon atoms of the hydrocarbon group is preferably 1 or more and 7 or less and more preferably 2 or more and 4 or less. Fluorinated cyclic carbonate, in which a hydrogen atom of the hydrocarbon group is substituted by a fluorine atom, may be also used.

Examples of the cyclic carbonate include ethylene carbonate (EC), propylene carbonate (PC), butylene carbonate (BC) and vinylene carbonate (VC). Examples of the fluorinated cyclic carbonate include compounds in which part or the whole of hydrogen atoms of ethylene carbonate (EC), propylene carbonate (PC), butylene carbonate (BC), vinylene carbonate (VC) or the like is substituted by a fluorine atom(s). There can be used, more specifically, for example, 4-fluoro-1,3-dioxolan-2-one (monofluoroethylene carbonate), (cis- or trans-)4,5-difluoro-1,3-dioxolan-2-one, 4,4-difluoro-1,3-dioxolan-2-one and 4-fluoro-5-methyl-1,3-dioxolan-2-one. The cyclic carbonate is, among those listed in the above, from the viewpoint of the voltage resistance and the conductivity, preferably ethylene carbonate, propylene carbonate, and 4-fluoro-1,3-dioxolan-2-one. The cyclic carbonate can be used singly or concurrently in two or more.

As the fluorine-containing phosphate esters, those represented by the following formula (4) are preferred.

O═P(—O—R₁′)(—O—R₂′)(—O—R₃′) (4)

wherein R₁′, R₂′ and R₃′ each independently represent alkyl group or fluorine-containing alkyl group, and at least one of R₁′, R₂′ and R₃′ is fluorine-containing alkyl group.

In formula (4), the numbers of carbon atoms of R₁′, R₂′ and R₃′ are preferably each independently 1 or more and 5 or less.

Examples of the fluorine-containing phosphate ester represented by formula (4) include 2,2,2-trifluoroethyl dimethyl phosphate, bis(trifluoroethyl) methyl phosphate, bistrifluoroethyl ethyl phosphate, tris(trifluoromethyl) phosphate, pentafluoropropyl dimethyl phosphate, heptafluorobutyl dimethyl phosphate, trifluoroethyl methyl ethyl phosphate, pentafluoropropyl methyl ethyl phosphate, heptafluorobutyl methyl ethyl phosphate, trifluoroethyl methyl propyl phosphate, pentafluoropropyl methyl propyl phosphate, heptafluorobutyl methyl propyl phosphate, trifluoroethyl methyl butyl phosphate, pentafluoropropyl methyl butyl phosphate, heptafluorobutyl methyl butyl phosphate, trifluoroethyl diethyl phosphate, pentafluoropropyl diethyl phosphate, heptafluorobutyl diethyl phosphate, trifluoroethyl ethyl propyl phosphate, pentafluoropropyl ethyl propyl phosphate, heptafluorobutyl ethyl propyl phosphate, trifluoroethyl ethyl butyl phosphate, pentafluoropropyl ethyl butyl phosphate, heptafluorobutyl ethyl butyl phosphate, trifluoroethyl dipropyl phosphate, pentafluoropropyl dipropyl phosphate, heptafluorobutyl dipropyl phosphate, trifluoroethyl propyl butyl phosphate, pentafluoropropyl propyl butyl phosphate, heptafluorobutyl propyl butyl phosphate, trifluoroethyl dibutyl phosphate, pentafluoropropyl dibutyl phosphate, heptafluorobutyl dibutyl phosphate, tris(2,2,3,3-tetrafluoropropyl) phosphate, tris(2,2,3,3,3-pentafluoropropyl) phosphate, tris(2,2,2-trifluoroethyl) phosphate, tris(1H,1H-heptafluorobutyl) phosphate and tris(1H,1H,5H-octafluoropentyl) phosphate.

Among these, fluorine-containing phosphate esters represented by the following formula (5) are preferred because of being high in the effect of preventing the electrolyte solution from decompose at high potential.

O═P(—O—R₄′)₃ (5)

wherein R₄′ is preferably fluorine-containing alkyl group having 1 to 5 carbon atoms.

As the fluorine-containing phosphate esters represented by formula (5), tris(2,2,2-trifluoroethyl) phosphate, tris(2,2,3,3,3-pentafluoropropyl) phosphate and tris(1H,1H-heptafluorobutyl) phosphate are exemplified, and tris(2,2,2-trifluoroethyl) phosphate is particularly preferred.

The fluorine-containing phosphate esters may be used alone or in combination of two or more thereof. By containing two or more types of the fluorine-containing phosphate esters, a secondary battery having high cycle characteristics may be obtained in some cases.

As the fluorine-containing ethers, those represented by the following formula (6) are preferred.

CₙH₂ₙ₊₁₋₁F₁—O—CₘH₂ₘ₊ₗ₋ₖFₖ (6)

wherein n is 1, 2, 3, 4, 5 or 6, m is 1, 2, 3 or 4, l is an integer of 0 to 2n+1, k is an integer of 0 to 2m+1, and at least one of l and k is 1 or more.

Examples of the fluorine-containing ether represented by formula (6) include 2,2,3,3,3-pentafluoropropyl 1,1,2,2-tetrafluoroethyl ether, 1,1,2,2-tetrafluoroethyl 2,2,2-trifluoroethyl ether, 1H, 1H, 2′H, 3H-decafluorodipropyl ether, 1,1,2,3,3,3-hexafluoropropyl 2,2-difluoroethyl ether, isopropyl 1,1,2,2-tetrafluoroethyl ether, propyl 1,1,2,2-tetrafluoroethyl ether, 1,1,2,2-tetrafluoroethyl 2,2,3,3-tetrafluoropropyl ether, 1H, 1H, 5H-perfluoropentyl 1,1,2,2-tetrafluoroethyl ether, 1H-perfluorobutyl 111-perfluoroethyl ether, methyl perfluoropentyl ether, methyl perfluorohexyl ether, methyl 1,1,3,3,3-pentafluoro-2-(trifluoromethyl)propyl ether, 1,1,2,3,3,3-hexafluoropropyl 2,2,2-trifluoroethyl ether, ethyl nonafluorobutyl ether, ethyl 1,1,2,3,3,3-hexafluoropropyl ether, 1H, 1H, 5H-octafluoropentyl 1,1,2,2-tetrafluoroethyl ether, 1H, 1H, 2′H-perfluorodipropyl ether, heptafluoropropyl 1,2,2,2-tetrafluoroethyl ether, 1,1,2,2-tetrafluoroethyl 2,2,3,3-tetrafluoropropyl ether, 2,2,3,3,3-pentafluoropropyl 1,1,2,2-tetrafluoroethyl ether, ethyl nonafluorobutyl ether, methyl nonafluorobutyl ether, 1,1-difluoroethyl 2,2,3,3-tetrafluoropropyl ether, bis(2,2,3,3-tetrafluoropropyl) ether, 1,1-difluoroethyl 2,2,3,3,3-pentafluoropropyl ether, 1,1-difluoroethyl 1H, 1H-heptafluorobutyl ether, 2,2,3,4,4,4-hexafluorobutyl difluoromethyl ether, bis(2,2,3,3,3-pentafluoropropyl) ether, nonafluorobutyl methyl ether, bis(1H, 1H-heptafluorobutyl) ether, 1,1,2,3,3,3-hexafluoropropyl 1H, 1H-heptafluorobutyl ether, 1H, 1H-heptafluorobutyl trifluoromethyl ether, 2,2-difluoroethyl 1,1,2,2-tetrafluoroethyl ether, bis(trifluoroethyl) ether, bis(2,2-difluoroethyl) ether, bis(1,1,2-trifluoroethyl) ether, 1,1,2-trifluoroethyl 2,2,2-trifluoroethyl ether, bis(2,2,3,3-tetrafluoropropyl) ether and the like.

Among these, from the viewpoint of voltage resistance and boiling point, at least one fluorine-containing ether selected from the group consisting of 1,1,2,2-tetrafluoroethyl 2,2,3,3-tetrafluoropropyl ether, 2,2,3,4,4,4-hexafluorobutyl difluoromethyl ether, 1,1-difluoroethyl 2,2,3,3-tetrafluoropropyl ether, 1,1,2,3,3,3-hexafluoropropyl 2,2-difluoroethyl ether, 1,1-difluoroethyl 1H, 1H-heptafluorobutyl ether, 1H, 1H, 2′H, 3H-decafluorodipropyl ether, bis(2,2,3,3,3-pentafluoropropyl)ether, 1H, 1H, 5H-perfluoropentyl 1,1,2,2-tetrafluoroethyl ether, bis(1H, 1H-heptafluorobutyl)ether, 1H, 1H, 2′H-perfluorodipropyl ether, 1,1,2,3,3,3-hexafluoropropyl 1H, 1H-heptafluorobutyl ether, 1H-perfluorobutyl 1H-perfluoroethyl ether, and bis(2,2,3,3-tetrafluoropropyl)ether is preferably used.

The fluorine-containing ether may be used singly or in combination of two or more types thereof. When two or more types of the fluorine-containing ethers are used in combination, cycle characteristics of the secondary battery may be improved as compared with the case of using only one type in some cases.

The total amount of the cyclic carbonate, the fluorine-containing phosphate ester and the fluorine-containing ether is preferably 70 volume % or more and more preferably 90 volume % or more, and may be 100 volume % with respect to the total amount of the electrolyte solvent. Herein, the volume may be determined from the weight of the solvent using the density of the solvent at room temperature (25° C.).

Given the properties and the compatibility of each solvent, it is preferred that volume ratios of the cyclic carbonate, the fluorine-containing phosphate ester and the fluorine-containing ether are within specific ranges respectively.

Since the cyclic carbonate has a high relative permittivity, the addition of the cyclic carbonate to an electrolyte solution improves the dissociation of a supporting salt and makes it easy for a sufficient conductivity to be imparted. The addition of the cyclic carbonate to an electrolyte solution has an advantage of improving the ionic mobility in the electrolyte. In addition, the cyclic carbonate has an improving effect of life characteristics caused by formation of film on negative electrode. However, the cyclic carbonate is a solvent that causes relatively large gas generation and capacity reduction at high voltage or high temperature. In view of these points, the amount of the cyclic carbonate is 10 volume % or more and less than 40 volume %, preferably 12 volume % or more and 35 volume % or less, and more preferably 15 volume % or more and 25 volume % or less with respect to the total amount of the cyclic carbonate, the fluorine-containing phosphate ester and the fluorine-containing ether.

The fluorine-containing phosphate ester has advantages that oxidation resistance is high and it is hardly decomposed. In addition, it is considered that it has also the effect of reducing gas generation. On the other hand, when the content is excessively large, there are problems of a decrease in the conductivity of the electrolyte solution because of high viscosity and a comparatively low dielectric constant and an increase in the resistance because of increasing film formation amount due to reductive decomposition. The amount of the fluorine-containing phosphate ester is 20 volume % or more and 50 volume % or less, preferably 25 volume % or more and 45 volume % or less, and more preferably 30 volume % or more and 40 volume % or less with respect to the total amount of the cyclic carbonate, the fluorine-containing phosphate ester and the fluorine-containing ether.

The fluorine-containing ether has an effect of preventing the fluorine-containing phosphate ester from forming the film. An electrolyte solution comprising a large amount of the fluorine-containing ether tends to have good cycle characteristics. On the other hand, when the content is excessively large, the viscosity of the electrolyte solution increases, and rate characteristics of the battery deteriorates. In addition, when the ratio of the fluorine-containing ether is high, it is difficult to mix the electrolyte solution uniformly. In view of these points, the amount of the fluorine-containing ether is 25 volume % or more and 70 volume % or less, preferably 30 volume % or more and 60 volume % or less, and more preferably 35 volume % or more and 55 volume % or less with respect to the total amount of the cyclic carbonate, the fluorine-containing phosphate ester and the fluorine-containing ether.

In one embodiment, in order to improve cycle characteristics of the battery, it is preferred that the solvent and the supporting salt can be mixed homogeneously. FIG. 3 is a three phase diagram showing a mix ratio range in gray color in which a specific amount of LiPF₆ cannot be mixed uniformly with an electrolyte solvent consisting of a cyclic carbonate, a fluorine-containing phosphate ester and a fluorine-containing ether. In FIG. 3, the addition amount of LiPF₆ is 1.0 mol per 1 L of the electrolyte solvent except as noted in parentheses. On the other hand, since the effect of improving cycle characteristics caused by the addition of the fluorine-containing ether is large, a battery excellent in cycle characteristics can be obtained as long as the volume ratio of the fluorine-containing ether is within the above mentioned range even with the electrolyte solution having a ratio in the region unable to mix uniformly shown in FIG. 3.

In the electrolyte solvent, the total volume of the fluorine-containing phosphate ester and the fluorine-containing ether is preferably larger than the volume of the cyclic carbonate, and more preferably equal or larger than twice the volume of the cyclic carbonate. When the cyclic carbonate is less than the fluorine-containing phosphate ester and the fluorine-containing ether, the gas generation can be reduced, and the resistance increase can be prevented.

An electrolyte solvent containing more fluorine-containing ether than cyclic carbonate is preferable. The amount of the fluorine-containing ether is preferably more than 50 volume %, more preferably 60 volume % or more, and most preferably 70 volume % or more with respect to the total amount of the cyclic carbonate and the fluorine-containing ether. When the content ratio of the fluorine-containing ether is higher than that of the cyclic carbonate, battery properties, such as capacity retention rate, may be improved. The amount of the fluorine-containing ether is preferably 87 volume % or less with respect to the total amount of the cyclic carbonate and the fluorine-containing ether.

The supporting salt is not particularly limited except that it comprises Li. Examples of the supporting salt include LiPF₆, LiAsF₆, LiAlCl₄, LiClO₄, LiBF₄, LiSbF₆, LiCF₃SO₃, LiC₄F₉SO₃, LiC(CF₃SO₂)₂, LiN(FSO₂)₂ (abbreviation: LiFSI), LiN(CF₃SO₂)₂, LiN(C₂F₅SO₂)₂, LiB₁₀Cl₁₀ and the like. In addition, the supporting salt includes lower aliphatic lithium carboxylate, chloroboran lithium, lithium tetraphenylborate, LiBr, LiI, LiSCN, LiCl and the like. Among them, LiPF₆ and LiFSI are especially preferred from the viewpoint of oxidation resistance, reduction resistance, stability, and ease of dissolution. The supporting salt may be used alone or in combination of two or more. The concentration of the supporting salt is preferably 0.4 mol or more and 1.5 mol or less, and more preferably 0.5 mol or more and 1.2 mol or less relative to 1 L of the electrolyte solvent.

Using LiFSI in at least part of the supporting salt is preferred. LiFSI dissociates in the electrolyte solution and generates a N(FSO₂)₂ anion (FSI anion). The FSI anion forms SEI film that prevents reaction between an active material and an electrolytic solution on the negative electrode and the positive electrode. Thereby, capacity retention rate after charge and discharge cycles is improved, and the gas generation can be prevented. The amount of LiFSI is preferably 20 mol % or more and 80 mol % or less and more preferably 30 mol % or more and 70 mol % or less with respect to the total amount of the supporting salt containing Li.

### <Separator>

The separator may be of any type as long as it prevents electron conduction between the positive electrode and the negative electrode, does not inhibit the permeation of charged substances, and has durability against the electrolyte solution. Specific examples of the material include polyolefins such as polypropylene and polyethylene, cellulose, polyesters such as polyethylene terephthalate and polybutylene terephthalate, polyimide, polyvinylidene fluoride, and aromatic polyamides (aramid) such as polymetaphenylene isophthalamide, polyparaphenylene terephthalamide and copolyparaphenylene 3,4′-oxydiphenylene terephthalamide, and the like. These can be used as porous films, woven fabrics, nonwoven fabrics or the like.

### <Insulation Layer>

An insulation layer may be formed on at least one surface of the positive electrode, the negative electrode and the separator. Examples of a method for forming the insulation layer include a doctor blade method, a dip coating method, a die coater method, a CVD method, a sputtering method, and the like. The insulation layer may be formed at the same time as the positive electrode, negative electrode or separator. Materials constituting the insulation layer include insulating filler such as aluminum oxide or barium titanate and a binder such as SBR or PVDF.

### <Structure of Lithium Secondary Battery>

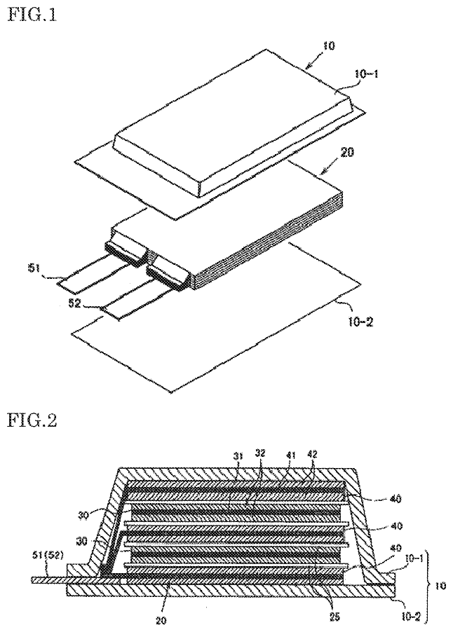

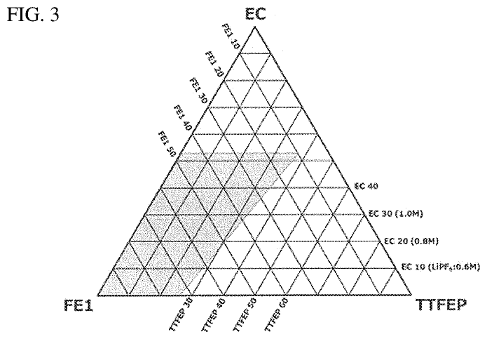

The lithium secondary battery according to the present embodiment may be, for example, a lithium secondary battery having a structure as shown in FIGS. 1 and 2. This lithium secondary battery comprises a battery element 20, a film package 10 housing the battery element 20 together with an electrolyte, and a positive electrode tab 51 and a negative electrode tab 52 (hereinafter these are also simply referred to as “electrode tabs”).

In the battery element 20, a plurality of positive electrodes 30 and a plurality of negative electrodes 40 are alternately stacked with separators 25 sandwiched therebetween as shown in FIG. 2. In the positive electrode 30, an electrode material 32 is applied to both surfaces of a metal foil 31, and also in the negative electrode 40, an electrode material 42 is applied to both surfaces of a metal foil 41 in the same manner. The present invention is not necessarily limited to stacking type batteries and may also be applied to batteries such as a winding type.

As shown in FIGS. 1 and 2, the lithium secondary battery may have an arrangement in which the electrode tabs are drawn out to one side of the outer package, but the electrode tab may be drawn out to both sides of the outer package. Although detailed illustration is omitted, the metal foils of the positive electrodes and the negative electrodes each have an extended portion in part of the outer periphery. The extended portions of the negative electrode metal foils are brought together into one and connected to the negative electrode tab 52, and the extended portions of the positive electrode metal foils are brought together into one and connected to the positive electrode tab 51 (see FIG. 2). The portion in which the extended portions are brought together into one in the stacking direction in this manner is also referred to as a “current collecting portion” or the like.

The film package 10 is composed of two films 10-1 and 10-2 in this example. The films 10-1 and 10-2 are heat-sealed to each other in the peripheral portion of the battery element 20 and hermetically sealed. In FIG. 1, the positive electrode tab 51 and the negative electrode tab 52 are drawn out in the same direction from one short side of the film package 10 hermetically sealed in this manner.

Of course, the electrode tabs may be drawn out from different two sides respectively. In addition, regarding the arrangement of the films, in FIG. 1 and FIG. 2, an example in which a cup portion is formed in one film 10-1 and a cup portion is not formed in the other film 10-2 is shown, but other than this, an arrangement in which cup portions are formed in both films (not illustrated), an arrangement in which a cup portion is not formed in either film (not illustrated), and the like may also be adopted.

### <Method for Manufacturing Lithium Secondary Battery>

The lithium secondary battery according to the present embodiment can be manufactured using a conventional method. An example of a method for manufacturing a lithium secondary battery will be described taking a stacked laminate type lithium secondary battery as an example. First, in the dry air or an inert atmosphere, the positive electrode and the negative electrode are placed to oppose to each other via a separator to form an electrode element. Next, this electrode element is accommodated in an outer package (container), an electrolyte solution is injected, and the electrodes are impregnated with the electrolyte solution. Thereafter, the opening of the outer package is sealed to complete the lithium secondary battery.

### <Assembled Battery>

A plurality of the lithium secondary batteries according to the present embodiment may be combined to form an assembled battery. The assembled battery may be configured by connecting two or more lithium secondary batteries according to the present embodiment in series or in parallel or in combination of both. The connection in series and/or parallel makes it possible to adjust the capacitance and voltage freely. The number of the lithium secondary batteries included in the assembled battery can be set appropriately according to the battery capacity and output.

### <Vehicle>

The lithium secondary battery or the assembled battery according to the present embodiment can be used in vehicles. Vehicles according to the present embodiment include hybrid vehicles, fuel cell vehicles, electric vehicles (besides four-wheel vehicles (cars, trucks, commercial vehicles such as buses, light automobiles, etc.), two-wheeled vehicle (bike) and tricycle), and the like. The vehicles according to the present embodiment is not limited to automobiles, it may be a variety of power source of other vehicles, such as a moving body like a train.

### EXAMPLE

Hereinafter, specific Examples to which the present invention is applied will be described, but the present invention is not limited to Examples, and is allowed to be carried out under suitable changes and modifications in the scope not exceeding its gist.

93 weight % of an over-lithiated lithium manganite having a composition represented by Li_{1.2}Ni_{0.2}Mn_{0.6}O₂ as a positive electrode active material, 3 weight % of polyvinylidene fluoride as a binder, and 4 weight % of powdered graphite as a conductive assisting agent were mixed uniformly to prepare a positive electrode mixture. The positive electrode mixture is dispersed into N-methyl-2-pyrolidone to prepare a positive electrode mixture slurry. The positive electrode mixture slurry was uniformly applied to one surface of an aluminum current collector. This was dried at 120° C., and then shaped by a punching die to produce a rectangular positive electrode (26 mm×28 mm). The unit weight of the positive electrode was 20.7 g/cm², and the density of the positive electrode was 2.9 g/cm³.

90 weight % of a carbon-coated silicon oxide (SiOC) having a 50% particle size D50 of 5 μm (carbon coating:silicon oxide=5:95 (weight ratio)) as a negative electrode active material, 8 weight % of polyacrylic acid as a binder, and 2 weight % of fibrous graphite as a conductive assisting agent were mixed uniformly to prepare a negative electrode mixture. The negative electrode mixture was dispersed into water to prepare a negative electrode mixture slurry. The slurry was uniformly applied to one surface of SUS foil and dried at about 50° C. Then this was shaped by a punching die to produce a rectangular negative electrode (28 mm×30 mm). The unit weight of the negative electrode was 3.1 g/cm², and the density of the negative electrode was 1.28 g/cm³.

A different electrolyte solution was prepared in each example. An electrolyte solvent was prepared by mixing ethylene carbonate (EC), tris(2,2,2-trifluoroethyl) phosphate (TTFEP) and 1,1,2,2-tetrafluoroethyl 2,2,3,3-tetrafluoropropyl ether (FE1) at a volume ratio shown in Table 1. Then an electrolytic solution was prepared by dissolving LiPF₆ in a molar amount shown in Table 1 with respect to 1 L of the obtained electrolyte solvent. In Comparative example 4, an electrolyte solvent prepared by mixing ethylene carbonate (EC) and diethyl carbonate (DEC) was used.

An aluminum (Al) tab for the positive electrode and a nickel (Ni) tab for the negative electrode were ultrasonically welded to the current collector terminals of the positive electrode and the negative electrode respectively. The positive electrode and the negative electrode were stacked via a separator (cellulose, 20 μm) so that the surface to which the positive electrode mixture was applied and the surface to which the negative electrode mixture was applied were opposed to each other, and these were packed in an aluminum (Al) laminate exterior film. The ratio of the negative electrode capacity to the positive electrode capacity was 1.2. Three sides of the exterior film except for an injection hole were thermally welded, and this was dried all night and all day. After drying, the produced electrolyte solution was injected so that the amount thereof was 1.6 times the void volume of the positive electrode, the negative electrode and the separator. The injection hole was thermally welded, and a stacking type lithium secondary battery was produced.

### <Initial Charge and Discharge and Gas Discharge>

Under an environment at 45° C., a constant current charging up to 4.5V at a current value of 0.1C was performed, and a constant current discharging down to 1.5V at a current value of 0.1C was performed. Note that C is a unit indicating a relative current amount, and 0.1C is a current value at which discharge ends in just 10 hours when a battery charged up to the nominal capacity value is subjected to constant current discharging.

Then a side of the thermally welded laminate exterior film was opened, and gas generated at the time of charge and discharge was released under vacuum.

### <Cycle Test>

After the constant current discharging up to 4.5 V at a current value of 0.2C, AC impedance measurement at intervals of 5 mV from 500 kHz to 0.1 Hz and volume measurement by Archimedes method were conducted, and these were taken as the initial values. After the measurement, a constant current discharging down to 1.5V at a current value of 0.3C was performed. Then cycle characteristics were evaluated by repeating a constant current charging (at 0.2C to 4.5V) and a constant current discharging (at 0.3C to 1.5V) 200 times. After 200 cycles, a constant current charging up to 4.5 V at a current value of 0.2C was performed, and then AC impedance measurement at intervals of 5 mV from 500 kHz to 0.1 Hz and volume measurement by Archimedes method were conducted. The ratio (%) of a measurement result at the 200th cycle to a measurement result at the first cycle in each measurement is described in the following Table 1. The cycle retention rate is a capacity retention rate at the 200th cycle when the discharge capacity at the first cycle is taken as 100%. The volume increase rate is a volume increase rate at charging at the 200th cycle when volume at charging at the first cycle is taken as 100%. The cell thickness increase rate is a cell thickness increase rate at charging at the 200th cycle when thickness at charging at the first cycle is taken as 100%. The resistance increase rate is a resistance increase rate at charging at the 200th cycle when resistance at charging at the first cycle is taken as 100%.

TABLE 1

| | EC/ | | | | Cell | |
|---|---|---|---|---|---|---|
| | TTFEP/ | | | | thick- | Resist- |
| | FE1 | | Cycle | Volume | ness | ance |
| | volume | LiPF₆ | retention | increase | increase | increase |
| | ratio | (mol/l) | rate (%) | rate (%) | rate (%) | rate (%) |
| Example 1 | 1/5/4 | 0.6 | 76 | 103 | 102 | 164 |
| Example 2 | 2/5/3 | 0.8 | 65 | 105 | 102 | 183 |
| Example 3 | 2/4/4 | 0.8 | 81 | 107 | 101 | 121 |
| Example 4 | 2/3/5 | 0.8 | 82 | 109 | 102 | 113 |
| Comparative | 3/5/2 | 1.0 | 52 | 105 | 102 | 222 |
| example 1 | | | | | | |
| Example 5 | 3/4/3 | 1.0 | 73 | 108 | 102 | 139 |
| Comparative | 4/6/0 | 1.0 | 24 | 104 | 103 | 264 |
| example 2 | | | | | | |
| Comparative | 4/5/1 | 1.0 | 34 | 106 | 105 | 220 |
| example 3 | | | | | | |
| Comparative | EC/DEC = | 1.0 | 69 | 119 | 101 | 161 |
| example 4 | 3/7 | | | | | |

Next, the supporting salt was changed, and battery characteristics were confirmed.

### Example 6

Each solvent was mixed such that EC/TTFEP/FE1 was 2/3/5, and an electrolyte solvent was prepared. 0.8 mol of LiPF₆ was dissolved per 1 L of this electrolyte solvent to prepare an electrolyte solution. A battery was produced with this electrolyte solution in the same manner as in Example 1, and the same test was conducted. The results are shown in Table 2.

### Example 7

Each solvent was mixed such that EC/TTFEP/FE1 was 2/3/5, and an electrolyte solvent was prepared. 0.6 mol of LiPF₆ and 0.2 mol of LiFSI were dissolved per 1 L of this electrolyte solvent to prepare an electrolyte solution. A battery was produced with this electrolyte solution in the same manner as in Example 1, and the same test was conducted. The results are shown in Table 2.

### Example 8

Each solvent was mixed such that EC/TTFEP/FE1 was 2/3/5, and an electrolyte solvent was prepared. 0.5 mol of LiPF₆ and 0.3 mol of LiFSI were dissolved per 1 L of this electrolyte solvent to prepare an electrolyte solution. A battery was produced with this electrolyte solution in the same manner as in Example 1, and the same test was conducted. The results are shown in Table 2.

### Example 9

Each solvent was mixed such that EC/TTFEP/FE1 was 2/3/5, and an electrolyte solvent was prepared. 0.3 mol of LiPF₆ and 0.5 mol of LiFSI were dissolved per 1 L of this electrolyte solvent to prepare an electrolyte solution. A battery was produced with this electrolyte solution in the same manner as in Example 1, and the same test was conducted. The results are shown in Table 2.

TABLE 2

| | | | | Cycle |
|---|---|---|---|---|
| | EC/TTFEP/FE1 | LiPF₆ | LiFSI | retention |
| | volume ratio | (mol/l) | (mol/l) | rate (%) |
| Example 6 | 2/3/5 | 0.8 | 0 | 78 |
| Example 7 | 2/3/5 | 0.6 | 0.2 | 81 |
| Example 8 | 2/3/5 | 0.5 | 0.3 | 83 |
| Example 9 | 2/3/5 | 0.3 | 0.5 | 83 |

Next, the binder was changed, and battery characteristics were confirmed.

### Example 10

A battery having the same constituents as in the Example 4 was evaluated in the same manner, but herein the number of cycles was increased to 300. Table 3 shows the ratio (%) of the discharge capacity at the 300th cycle to the discharge capacity at the first cycle as a cycle retention rate.

### Comparative Example 5

A battery having the same constituents as in the Example 4 was produced except that the negative electrode binder was changed from the polyacrylic acid to a polyimide. This battery was evaluated in the same manner, but herein the number of cycles was increased to 300. Table 3 shows the ratio (%) of the discharge capacity at the 300th cycle to the discharge capacity at the first cycle as a cycle retention rate.

TABLE 3

| | | | Negative | Cycle |
|---|---|---|---|---|
| | EC/TTFEP/FE1 | LiPF₆ | electrode | retention |
| | volume ratio | (mol/l) | binder | rate (%) |
| Example 10 | 2/3/5 | 0.8 | Polyacrylic | 72 |
| | | | acid | |
| Comparative | 2/3/5 | 0.8 | Polyimide | 37 |
| example 5 | | | | |

The whole or part of the exemplary embodiments disclosed above can be described as, but not limited to, the following supplementary notes.

### (Supplementary Note 1)

A lithium secondary battery,
wherein a positive electrode comprises a positive electrode active material represented by the following formula (1) or (2); a negative electrode comprises at least one negative electrode active material selected from the group consisting of metal silicon, alloys comprising silicon and silicon oxides represented by a composition formula SiOₓ where 0<x≤2, and a polyacrylic acid; and an electrolyte solution comprises an electrolyte solvent comprising a cyclic carbonate, a fluorine-containing phosphate ester and a fluorine-containing ether, and a supporting salt comprising Li,
wherein an amount of the cyclic carbonate is 10 volume % or more and less than 40 volume %, an amount of the fluorine-containing phosphate ester is 20 volume % or more and 50 volume % or less, and an amount of the fluorine-containing ether is 25 volume % or more and 70 volume % or less with respect to a total amount of the cyclic carbonate, the fluorine-containing phosphate ester and the fluorine-containing ether,

xLi₂MnO₃—(1—x)LiMO₂ (1)

wherein x is in a range of 0.1<x<0.8, and M is at least one element selected from the group consisting of Mn, Fe, Co, Ni, Ti, Al and Mg, and

Li(LiₓM_{1-x-y}Mn_{y})O₂ (2)

wherein x and y are in ranges of 0.1≤x≤0.3 and 0.33≤y≤0.8, and M is at least one element selected from the group consisting of Fe, Co, Ni, Ti, Al and Mg.

### (Supplementary Note 2)

The lithium secondary battery according to supplementary note 1, wherein a total volume of the fluorine-containing phosphate ester and the fluorine-containing ether is larger than a volume of the cyclic carbonate.

(Supplementary note 3)

The lithium secondary battery according to supplementary note 1 or 2, wherein an amount of the fluorine-containing ether is more than 50 volume % with respect to a total amount of the cyclic carbonate and the fluorine-containing ether.

### (Supplementary Note 4)

The lithium secondary battery according to any one of supplementary notes 1 to 3, wherein an amount of the supporting salt comprising Li is 0.4 mol or more and 1.5 mol or less relative to 1 L of the electrolyte solvent.

(Supplementary note 5)

The lithium secondary battery according to any one of supplementary notes 1 to 4, wherein the supporting salt comprising Li comprises LiN(FSO₂)₂.

### (Supplementary Note 6)

The lithium secondary battery according to supplementary note 5, wherein an amount of LiN(FSO₂)₂ is 20 mol % or more and 80 mol % or less with respect to a total amount of the supporting salt containing Li.

(Supplementary note 7)

The lithium secondary battery according to any one of supplementary notes 1 to 6, wherein the cyclic carbonate is at least one selected from the group consisting of ethylene carbonate, propylene carbonate, vinylene carbonate, and compounds in which at least part of hydrogen atoms thereof are replaced with fluorine atoms.

### (Supplementary Note 8)

The lithium secondary battery according to any one of supplementary notes 1 to 7, wherein the fluorine-containing phosphate ester is represented by the following formula (3),

O═P(—O—R₁′)(—O—R₂′)(—O—R₃′) (3)

wherein R₁′, R₂′ and R₃′ each independently represent alkyl group or fluorine-containing alkyl group; and at least one of R₁′, R₂′ and R₃′ is fluorine-containing alkyl group.

### (Supplementary Note 9)

The lithium secondary battery according to any one of claims 1 to 8, wherein the fluorine-containing ether is represented by the following formula (4),

CₙH₂ₙ₊₁₋₁F₁—O—CₘH₂ₘ₊ₗ₋ₖFₖ (4)

wherein n is 1, 2, 3, 4, 5 or 6, m is 1, 2, 3 or 4, l is an integer of 0 to 2n+1, k is an integer of 0 to 2m+1, and at least one of l and k is 1 or more.
(Supplementary note 10)

The lithium secondary battery according to any one of supplementary notes 1 to 9, wherein the amount of the cyclic carbonate is 15 volume % or more and 25 volume % or less with respect to the total amount of the cyclic carbonate, the fluorine-containing phosphate ester and the fluorine-containing ether.

### (Supplementary Note 11)

A method for manufacturing a lithium secondary battery, comprising the steps of:
fabricating an electrode element by stacking a negative electrode and a positive electrode via a separator, and
encapsulating the electrode element and an electrolyte solution into an outer package,
wherein the positive electrode comprises a positive electrode active material represented by the following formula (1) or (2); the negative electrode comprises at least one negative electrode active material selected from the group consisting of metal silicon, alloys comprising silicon and silicon oxides represented by a composition formula SiOₓ where 0<x≤2, and a polyacrylic acid; and the electrolyte solution comprises an electrolyte solvent comprising a cyclic carbonate, a fluorine-containing phosphate ester and a fluorine-containing ether, and a supporting salt comprising Li,
wherein an amount of the cyclic carbonate is 10 volume % or more and less than 40 volume %, an amount of the fluorine-containing phosphate ester is 20 volume % or more and 50 volume % or less, and an amount of the fluorine-containing ether is 25 volume % or more and 70 volume % or less with respect to a total amount of the cyclic carbonate, the fluorine-containing phosphate ester and the fluorine-containing ether,

xLi₂MnO₃—(1—x)LiMO₂ (1)

wherein x is in a range of 0.1<x<0.8, and M is at least one element selected from the group consisting of Mn, Fe, Co, Ni, Ti, Al and Mg, and

Li(LiₓM_{1-x-y}Mn_{y})O₂ (2)

wherein x and y are in ranges of 0.1≤x≤0.3 and 0.33≤y≤0.8, and M is at least one element selected from the group consisting of Fe, Co, Ni, Ti, Al and Mg.

This application claims priority right based on Japanese patent application No. 2016-179359, filed on Sep. 14, 2016, the entire disclosure of which is hereby incorporated by reference.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

### INDUSTRIAL APPLICABILITY

The lithium secondary battery according to the present invention can be utilized in, for example, all the industrial fields requiring a power supply and the industrial fields pertaining to the transportation, storage and supply of electric energy. Specifically, it can be used in, for example, power supplies for mobile equipment such as cellular phones and notebook personal computers; power supplies for electrically driven vehicles including an electric vehicle, a hybrid vehicle, an electric motorbike and an electric-assisted bike, and moving/transporting media such as trains, satellites and submarines; backup power supplies for UPSs; and electricity storage facilities for storing electric power generated by photovoltaic power generation, wind power generation and the like.

### EXPLANATION OF REFERENCE

10 film package
20 battery element
25 separator
30 positive electrode
40 negative electrode

1. A lithium secondary battery,
wherein a positive electrode comprises a positive electrode active material represented by the following formula (1) or (2); a negative electrode comprises at least one negative electrode active material selected from the group consisting of metal silicon, alloys comprising silicon and silicon oxides represented by a composition formula SiOₓ where 0<x≤2, and a polyacrylic acid; and an electrolyte solution comprises an electrolyte solvent comprising a cyclic carbonate, a fluorine-containing phosphate ester and a fluorine-containing ether, and a supporting salt comprising Li,
wherein an amount of the cyclic carbonate is 10 volume % or more and less than 40 volume %, an amount of the fluorine-containing phosphate ester is 20 volume % or more and 50 volume % or less, and an amount of the fluorine-containing ether is 25 volume % or more and 70 volume % or less with respect to a total amount of the cyclic carbonate, the fluorine-containing phosphate ester and the fluorine-containing ether,
xLi₂MnO₃—(1—x)LiMO₂ (1)
wherein x is in a range of 0.1<x<0.8, and M is at least one element selected from the group consisting of Mn, Fe, Co, Ni, Ti, Al and Mg, and
Li(LiₓM_{1-x-y}Mn_{y})O₂ (2)
wherein x and y are in ranges of 0.1≤x≤0.3 and 0.33≤y≤0.8, and M is at least one element selected from the group consisting of Fe, Co, Ni, Ti, Al and Mg.

2. The lithium secondary battery according to claim 1, wherein a total volume of the fluorine-containing phosphate ester and the fluorine-containing ether is larger than a volume of the cyclic carbonate.

3. The lithium secondary battery according to claim 1, wherein an amount of the fluorine-containing ether is more than 50 volume % with respect to a total amount of the cyclic carbonate and the fluorine-containing ether.

4. The lithium secondary battery according to claim 1, wherein an amount of the supporting salt comprising Li is 0.4 mol or more and 1.5 mol or less relative to 1 L of the electrolyte solvent.

5. The lithium secondary battery according to claim 1, wherein the supporting salt comprising Li comprises LiN(FSO₂)₂.

6. The lithium secondary battery according to claim 5, wherein an amount of LiN(FSO₂)₂ is 20 mol % or more and 80 mol % or less with respect to a total amount of the supporting salt containing Li.

7. The lithium secondary battery according to claim 1, wherein the cyclic carbonate is at least one selected from the group consisting of ethylene carbonate, propylene carbonate, vinylene carbonate, and compounds in which at least part of hydrogen atoms thereof are replaced with fluorine atoms.

8. The lithium secondary battery according to claim 1, wherein the fluorine-containing phosphate ester is represented by the following formula (3),
O═P(—O—R₁′)(—O—R₂′)(—O—R₃′) (3)
wherein R₁′, R₂′ and R₃′ each independently represent alkyl group or fluorine-containing alkyl group; and at least one of R₁′, R₂′ and R₃′ is fluorine-containing alkyl group.

9. The lithium secondary battery according to claim 1, wherein the fluorine-containing ether is represented by the following formula (4),
CₙH₂ₙ₊₁₋₁F₁—O—CₘH₂ₘ₊ₗ₋ₖFₖ (4)
wherein n is 1, 2, 3, 4, 5 or 6, m is 1, 2, 3 or 4, l is an integer of 0 to 2n+1, k is an integer of 0 to 2m+1, and at least one of l and k is 1 or more.

10. The lithium secondary battery according to claim 1, wherein the amount of the cyclic carbonate is 15 volume % or more and 25 volume % or less with respect to the total amount of the cyclic carbonate, the fluorine-containing phosphate ester and the fluorine-containing ether.

11. A method for manufacturing a lithium secondary battery, comprising the steps of:
fabricating an electrode element by stacking a negative electrode and a positive electrode via a separator, and
encapsulating the electrode element and an electrolyte solution into an outer package,
wherein the positive electrode comprises a positive electrode active material represented by the following formula (1) or (2); the negative electrode comprises at least one negative electrode active material selected from the group consisting of metal silicon, alloys comprising silicon and silicon oxides represented by a composition formula SiOₓ where 0<x≤2, and a polyacrylic acid; and the electrolyte solution comprises an electrolyte solvent comprising a cyclic carbonate, a fluorine-containing phosphate ester and a fluorine-containing ether, and a supporting salt comprising Li,
wherein an amount of the cyclic carbonate is 10 volume % or more and less than 40 volume %, an amount of the fluorine-containing phosphate ester is 20 volume % or more and 50 volume % or less, and an amount of the fluorine-containing ether is 25 volume % or more and 70 volume % or less with respect to a total amount of the cyclic carbonate, the fluorine-containing phosphate ester and the fluorine-containing ether,
xLi₂MnO₃—(1—x)LiMO₂ (1)
wherein x is in a range of 0.1<x<0.8, and M is at least one element selected from the group consisting of Mn, Fe, Co, Ni, Ti, Al and Mg, and
Li(LiₓM_{1-x-y}Mn_{y})O₂ (2)
wherein x and y are in ranges of 0.1≤x≤0.3 and 0.33≤y≤0.8, and M is at least one element selected from the group consisting of Fe, Co, Ni, Ti, Al and Mg.
